(19) United States
(12) Patent Application Publication
(10) Pub. No.: US 2016/0202101 A1
(43) Pub. Date: Jul. 14, 2016

(54) SENSOR STRUCTURES AND METHODS OF FORMING USING THREE-DIMENSIONAL PRINTING TECHNIQUES

(71) Applicant: Douglas Ray Sparks, Warren, IN (US)

(72) Inventor: Douglas Ray Sparks, Warren, IN (US)

(21) Appl. No.: 14/993,809

(22) Filed: Jan. 12, 2016

Related U.S. Application Data
(60) Provisional application No. 62/125,014, filed on Jan. 12, 2015.

(51) Int. Cl. G01F 1/84; B23K 15/00; B22F 3/105; B22F 3/24; C21D 9/00; C21D 1/26; C25F 3/16; B22F 7/02; B23K 26/342; B22F 5/00

(52) U.S. Cl. CPC G01F 1/8472; B23K 26/342; B23K 15/0086; B22F 3/1055; B22F 5/00; C21D 9/0068; C21D 1/26; C25F 3/16; B22F 7/02; B22F 3/24; B33Y 10/00

(57) ABSTRACT

Three-dimensional printing techniques suitable for producing sensor structures, and sensor structures formed thereby. Such a sensor structure includes a support element coupled to a sensing element, and is formed by a three-dimensional printing technique that forms the support element and the sensing element as a single integral component by fusing particles fused together with a high energy beam.

### CROSS REFERENCE TO RELATED APPLICATIONS

This application claims the benefit of U.S. Provisional Application No. 62/125,014, filed Jan. 12, 2015, the contents of which are incorporated herein by reference.

### BACKGROUND OF THE INVENTION

The present invention generally relates to sensors and fabrication methods for making sensor structures. The invention particularly relates to sensor structures and methods of forming such structures using three-dimensional printing techniques.

A wide variety of techniques have been employed to produce sensors of various types. Such techniques have included metalworking processes performed on metals to produce sensor structures, for example, diaphragms for pressure sensors, tubes for resonating Coriolis mass flow and density sensors, and various types of blades, flow restrictors, tubes, diaphragms, capacitive plates, and flow obstructions for use in thermal, vortex, rotary, differential pressure flow meters, density meters, and other types of sensors. As a nonlimiting example, FIG. 1 represents a Coriolis mass flow sensor 10 produced by metalworking to comprise a pair of resonating tubes 12.

Silicon micromachining techniques have also been employed to produce sensor structures of microelectromechanical systems (MEMS), which produce sensors having much smaller feature sizes than possible for the sensor 10 represented in FIG. 1. Nonlimiting examples include pressure sensors and microfluidic devices produced by micromachining techniques such as bulk etching and surface thin-film etching, as reported in U.S. Pat. No. 6,477,901 to Tadigadapa et al. FIG. 2 represents such a microfluidic device 20 suitable for use as a Coriolis-based flow sensor. The device 20 is represented as having a U-shaped micromachined tube 22 extending from a base 24 on a substrate 26, with a freestanding portion of the tube 22 suspended above a surface of the substrate 26 to define a gap therebetween. The substrate 12 may be formed of silicon or another semiconductor material, quartz, glass, ceramic, metal, polymeric material, composite material, etc. The tube 22 may be micromachined from silicon, doped silicon or another semiconductor material, silicon carbide, quartz or another glass material, ceramic materials, metallic materials, and composite materials. The substrate 26 and tube 22 may be fabricated separately, after which the tube 22 is attached as a unitary member to the substrate 26. The freestanding portion of the tube 22 is generally U-shaped, though other shapes—both simpler and more complex—are also possible.

Under some circumstances, micromachining techniques used to produce diaphragms, tubes, and other sensor structures result in small holes, for example, on the order of about 1 to 5 micrometers in width, that must be closed. Such holes may be closed by a film deposition process, for example, an oxide, nitride or polysilicon film deposited by chemical vapor deposition (CVD), as also reported in Tadigadapa et al.

### BRIEF DESCRIPTION OF THE INVENTION

The present invention provides three-dimensional printing techniques suitable for producing sensor structures.

According to one aspect of the invention, a sensor structure comprises at least a support element coupled to a sensing element, wherein the support and sensing elements are a single integral component formed of particles fused together by a three-dimensional printing technique.

According to another aspect of the invention, a sensor structure comprising at least a support element coupled to a sensing element is formed by a three-dimensional printing technique that forms the support element and the sensing element as a single integral component by fusing particles fused together with a scanning electron, laser or ion beam.

Technical effects of the sensor structure and method described above preferably include the ability to produce the sensor structure to have small feature sizes suitable for use in microelectromechanical systems, but without processing restrictions and requirements typically encountered when fabricating sensor structures using traditional micromachining techniques.

Other aspects and advantages of this invention will be better appreciated from the following detailed description.

### BRIEF DESCRIPTION OF THE DRAWINGS

FIG. 1 represents a Coriolis mass flow sensor of a type produced by metalworking in accordance with the prior art.

FIG. 2 represents a Coriolis mass flow sensor of a type produced by micromachining techniques in accordance with the prior art.

FIGS. 3A through 3D schematically represent processing steps of a 3-D printing technique that may be performed to produce a microfluidic device with a resonating tube through which a fluid flows in accordance with a nonlimiting embodiment of this invention.

FIG. 4 schematically represents an additional processing steps that may be performed to facilitate the deposition of additional layers on the tube of FIGS. 3A through 3D.

FIG. 5 schematically represents a cross-sectional view of a tube produced by the processing steps of FIG. 1.

FIG. 6 schematically represents an additional processing step that may be performed to close porosity in the tube of FIG. 4.

FIG. 7 schematically represents another processing step that may be performed to close porosity in the tube of FIG. 4.

FIG. 8 schematically represents a plan view of a microfluidic device with a resonating tube through which a fluid flows in accordance with a nonlimiting embodiment of this invention.

FIGS. 9A and 9B schematically represent plan and side views, respectively, of a microfluidic device with a resonating tube in accordance with another nonlimiting embodiment of this invention.

FIGS. 10A, 10B and 10C schematically represent plan, side and end views, respectively, of another microfluidic device with resonating tubes in accordance with a nonlimiting embodiment of this invention.

FIGS. 11A through 11D schematically represent processing steps for creating a drive mechanism on a resonating tube of a microfluidic device produced by a 3-D printing technique in accordance with a nonlimiting embodiment of this invention.

FIG. 12 schematically represents a cross-sectional view of a pressure sensor that may be produced using a 3-D printing technique in accordance with a nonlimiting embodiment of this invention.

### DETAILED DESCRIPTION OF THE INVENTION

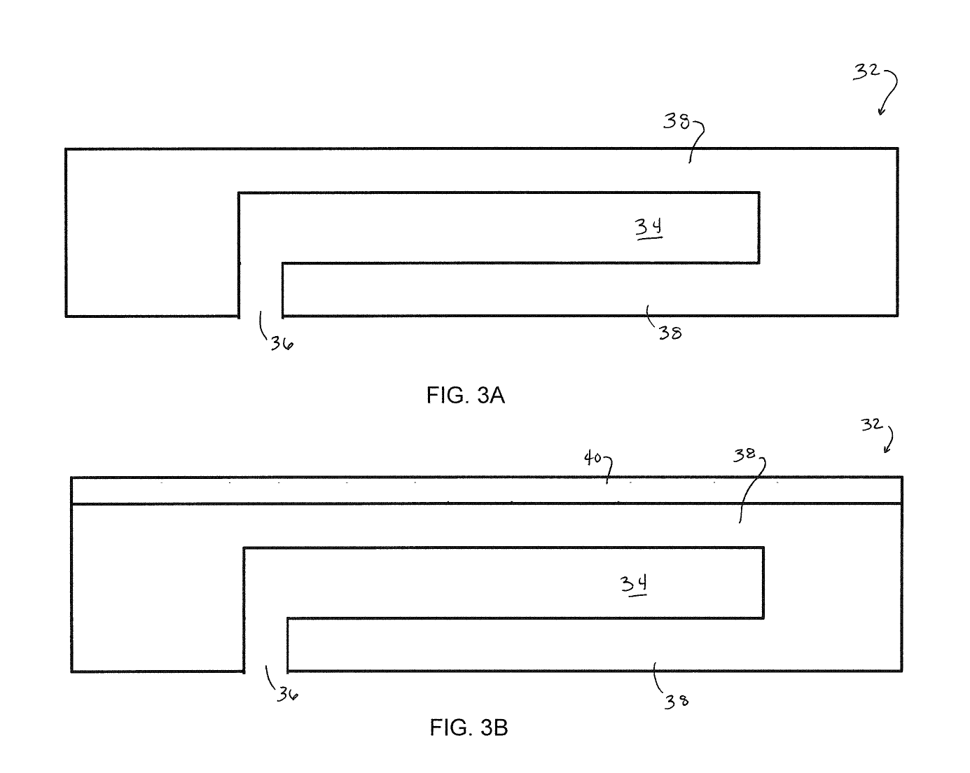

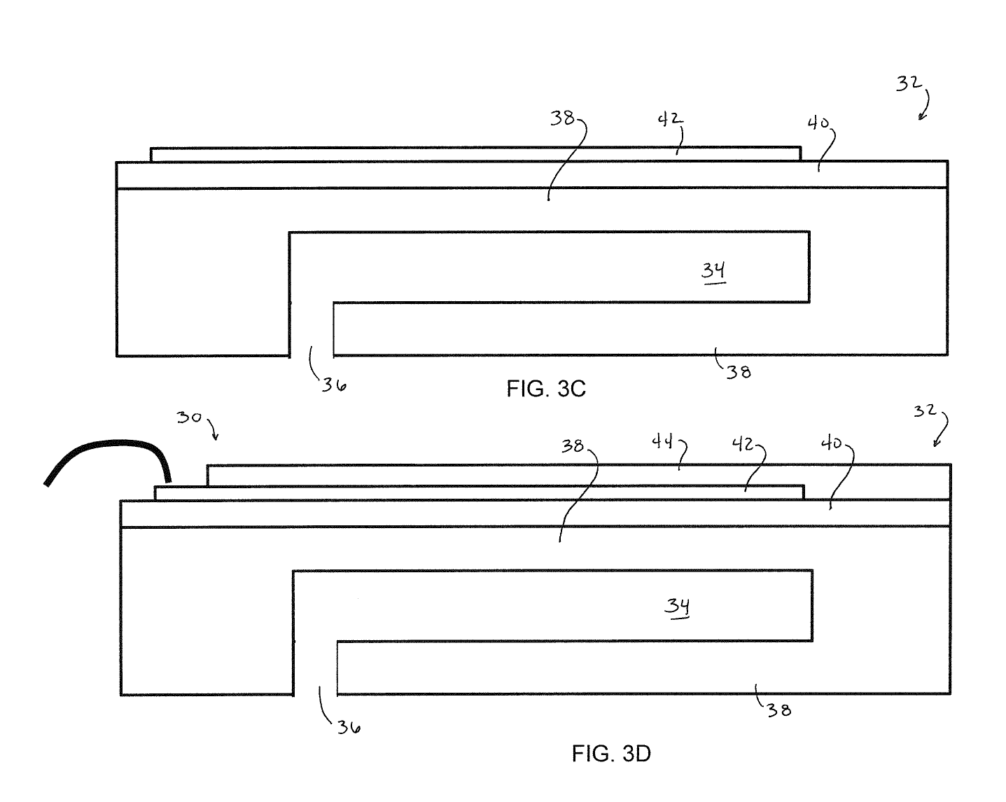

FIGS. 3 through 12 schematically represent sensor structures and methods of forming such structures using three-dimensional (3D) printing techniques in accordance with certain nonlimiting aspects of the invention. As known in the art, 3D printing is an additive manufacturing (AM) technique, a term that broadly refers to processes that entail fusing powders to form a solid three-dimensional net or near-net-shape (NNS) object by sequentially forming the shape of the object one layer at a time. 3D printing commonly uses an energy beam, for example, a laser beam, electron (E) beam, or ion beam, that is scanned over a layer of powder material to sinter or melt the material and produce a solid fused layer of the desired object. In addition to being capable of fabricating complex objects from a wide variety of materials, 3D printing techniques are capable of integrating the use of computer-aided design (CAD) models to produce objects having complex geometries. CAD models enable changes in sensor structure designs to be quickly made.

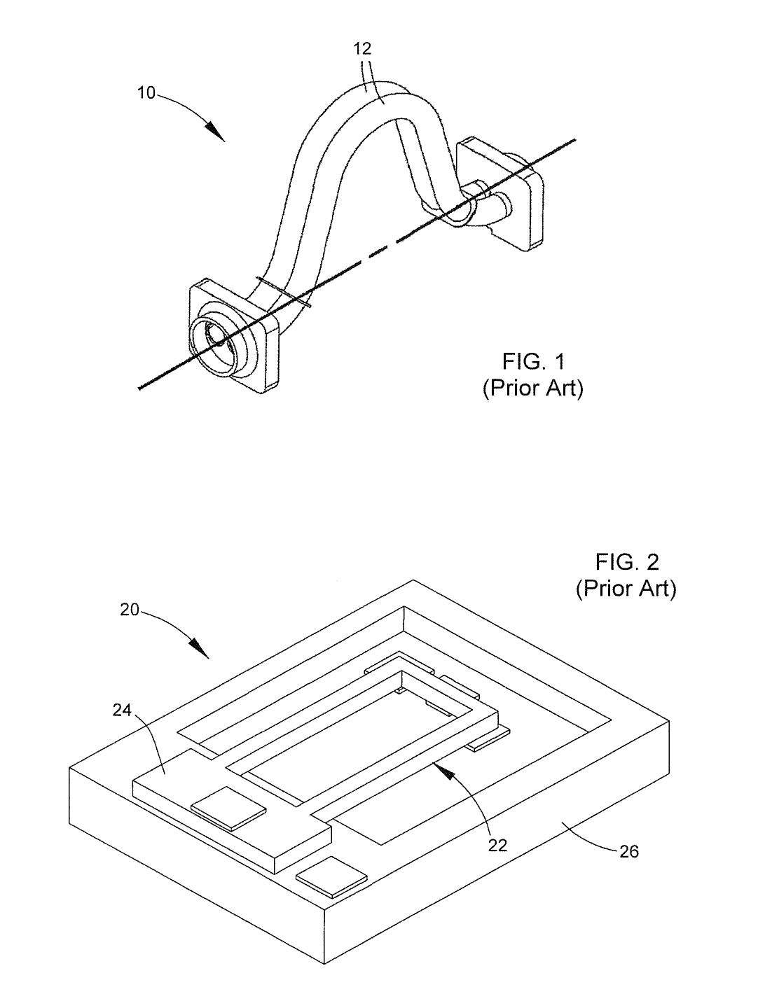

A wide variety of powder materials may be used to produce sensor structures of the present invention, notable but nonlimiting examples of which include metal, plastic, and glass materials. Particularly preferred but nonlimiting powder materials include metals such as titanium (and its alloys), tantalum (and its alloys), zirconium (and its alloys), tungsten (and its alloys), and stainless steels. The invention will be particularly described in reference to the fabrication of sensor structures comprising a support element and at least one sensing element, for example, diaphragms and/or tubes for pressure sensors and microfluidic devices, though it should be understood that the invention is not so limited. A preferred aspect of the invention is that such structures can be produced to have sufficiently small feature sizes to be suitable for use in microelectromechanical systems (MEMS), such that the sensor structures can occupy an area of 2 cm×2 cm or smaller and have feature sizes of 20 micrometers or less, which is much smaller than possible for the sensor 10 represented in FIG. 1.

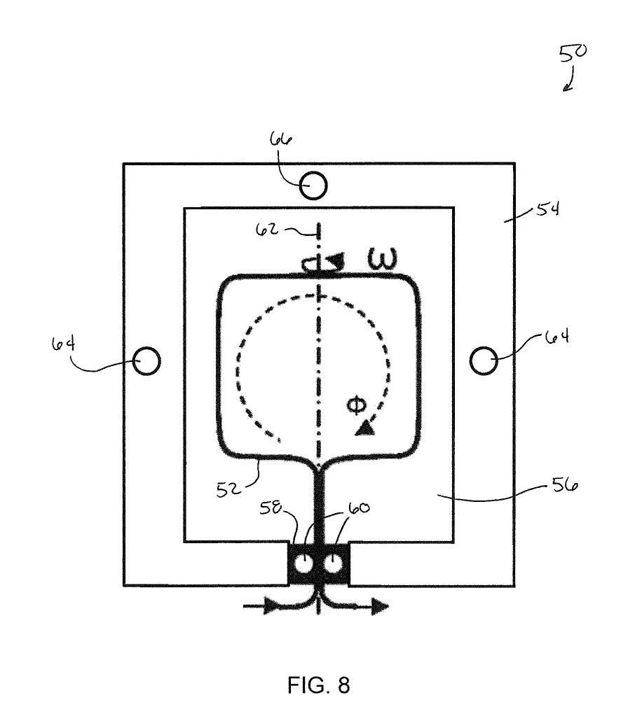

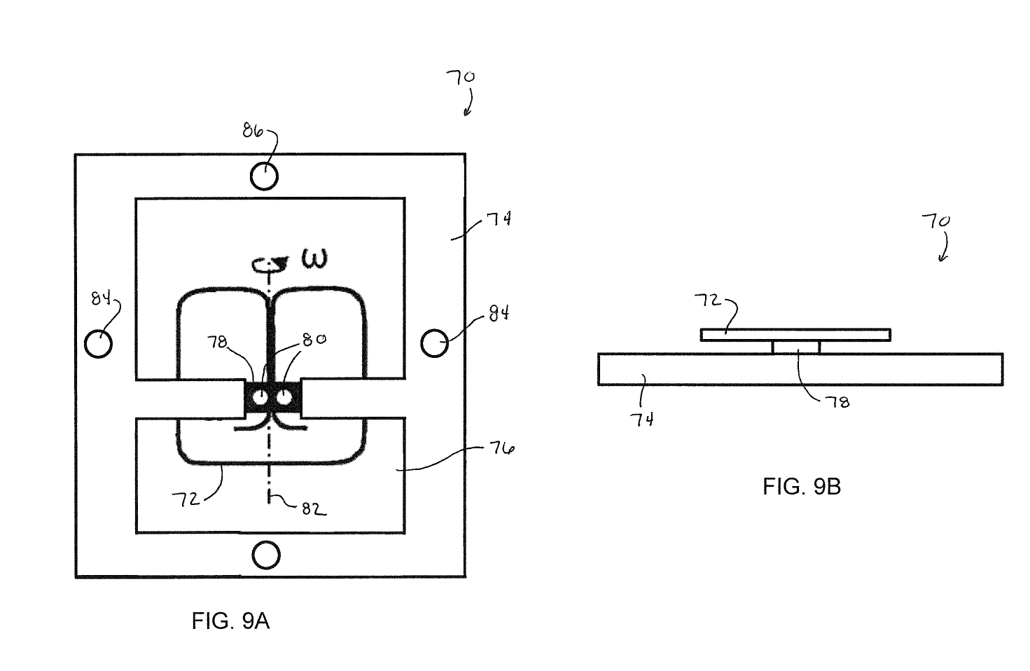

Referring to FIGS. 3A through 3D, manufacturing steps are represented for producing a freestanding tube 32 of a microfluidic device 30 (FIG. 3D) using a 3D printing technique. The tube 32 may be a resonating tube of a Coriolis-based mass flow sensor or a density, viscosity or binary concentration sensor, and as such constitutes a sensing element of the device 30. In FIG. 3A, the tube 32 may be printed using a selective electron, laser or ion beam scanning fabrication method. The configuration of the tube 32 represented in FIGS. 3A-3D is based on the U-shaped tube 22 of FIG. 2, though various other shapes are foreseeable including configurations discussed below in reference to FIGS. 8, 9A-B, 10A-B, and 11A-E. The tube 32 is depicted as defining a fluid channel 34 coupled to inlet and outlet ports 36 (of which only one is visible in the cross-sectional view of FIGS. 3A-3D). Whereas the ports 36 are represented in FIGS. 3A-D as transverse or otherwise not aligned with the channel 34, the tube 32 may be printed so that each port 36 is side-mounted and in line (e.g., coaxial) with a portion of the channel 34, eliminating a bend and hence reducing the pressure drop across the tube 32. The tube 32 has a tube wall 38 that surrounds and defines the fluid channel 34. The thickness of the tube wall 38 may range from about 1 micrometer to more than 100 micrometers in thickness, more preferably within a range of about 20 to 100 micrometers. To produce structural features of such small size, a photomask or metal or glass orifice or cylinder may be used to confine the energy beam.

Because particle size and the thicknesses of the individual sintered layers formed by fusing the particles with an energy beam effect the interior and exterior surface characteristics of the tube 32, there is a general preference for using small particles, for example, maximum dimensions of preferably not greater than 10 micrometers and more preferably about 10 to about 100 nanometers, and thin individual sintered layers, for example, maximum thicknesses of preferably not greater than 2000 micrometers and more preferably up to about 10 micrometers. The wall 38 can be initial produced to be thicker than the final intended dimensions for the tube 32, allowing for trimming the tube 32 to alter a mechanical property thereof (e.g., resonant frequency) as well as smoothing of the interior surface of the tube wall 38 using an electropolishing or plasma etching technique to further promote flow characteristics within the channel 34.

FIG. 3B represents an optional step of depositing an electrically insulating layer 40 on the tube, for example, by a 3D printing, CVD, plasma-enhanced CVD (PECVD), spraying, sputtering, or evaporation technique, allowing for the printing and patterning one or more electrical features 42 on the tube 32 as represented in FIG. 3C, for example, metal runners, bond pads, optical films for optical sensing, piezoelectric films for drive and sensing elements, and capacitive, magnetic, inductive, piezoresistive, and bimetallic films for drive and sensing elements.

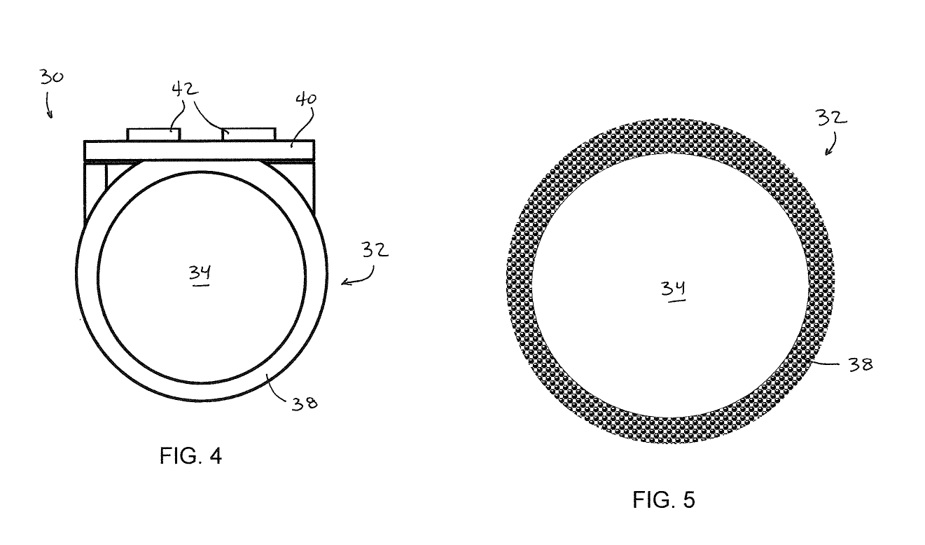

According to preferred aspects of the invention, the tube 32 and its interior channel 34 preferably have circular or otherwise round shapes, which can significantly reduce turbulence, bubble-trapping and nucleation of a fluid flowing through the channel 34. FIG. 4 schematically represents a nonlimiting example of a suitable cross-section of the tube 32, as well as one approach that involves creating a platform with the insulating layer 40 on which the electrical feature(s) 42 can be supported. Thereafter, FIG. 3D represents a passivation layer 44 deposited on the electrical feature(s) 42.

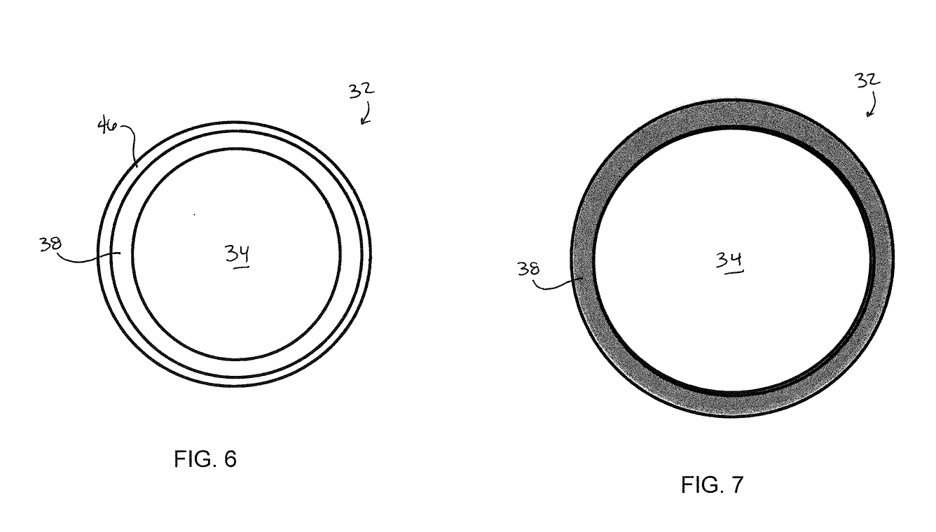

As schematically represented in FIG. 5, sintered structures produced by 3D printing metal and other materials having high melting temperatures are typically and often inherently porous, containing small pores that may be as small as about 1 micrometer or less. As such, additional processing steps are preferably undertaken to sufficiently reduce porosity so that the tube 32 is fluid-tight or at least liquid-tight. For example, the tube 32 may be annealed in an inert or reducing atmosphere (e.g., hydrogen) at high temperature and pressure to increase surface smoothness and reduce porosity, for example, to levels of less than 5% by volume, preferable less than 1% by volume. In addition or alternately, porosity may be reduced by depositing a film on the exterior and/or interior of the tube 32, as schematically represented in FIGS. 6 and 7. For example, non-line-of-sight film deposition techniques including CVD, PECVD, low pressure chemical vapor deposition (LPCVD), flame pyrolysis, and other processes can be used to deposit films of sufficient thickness (e.g., about 1 to 2 micrometers) to seal the interior and/or exterior surfaces of the tube 32, as schematically represented by a layer 46 in FIG. 6. For example, a layer 46 of tungsten, silicon, carbon, glass, diamond, polymer (for example, parylene), or ceramic (for example, carbides, nitrides, oxides, and oxynitride) is capable of sealing the porosity within the walls 38 of the tube 32. Evaporation, sputtering, spraying, ionized plasma deposition, dipping, electroplating, electroless plating and thermal decomposition are additional coating methods capable of sealing porosity. As a nonlimiting example, the layer 46 may be deposited by electroplating, electroless plating, or thermal decomposition using a liquid metallo-organic or metal salt. The material deposited to seal the porosity can be the same as the material of the fused particles, for example, a titanium layer 46 on a tube 32 formed of fused titanium particles, or an Fe—Ni—Cr stainless steel layer 46 on a tube 32 formed of fused Fe—Ni—Cr stainless steel particles. Alternatively, the material(s) deposited to seal the porosity can be different from the material of the fused particles and selected to promote other desired properties of the tube 32, for example, the strength, corrosion resistance, and/or wear resistance of the tube walls 38.

FIG. 7 represents the porosity within the tube walls 38 as having been filled instead of simply overcoated. As an example, electroplating and electroless plating techniques can be utilized to reduce porosity by depositing metallic materials that are capable of infiltrating and optionally alloying with a fused metallic powder material that forms the tube 32. As examples, the powder and infiltrated materials may remain as discrete constituents within the fused layers to form a composite material, or may form a liquid eutectic that permeates the porosity when exposed to an energy beam. In either case, the resulting composite or alloyed material may be stronger, more corrosion resistant, and/or more wear resistant than the fused powder material or infiltrated material. Particular but nonlimiting examples include depositing by CVD a layer of tungsten or polycrystalline silicon on a titanium tube 32, and then annealing the tube 32 to form, respectively, a TiW alloy or a TiSi alloy or silicide that seals porosity within the tube 32. As another example, gases generated during CVD and PECVD techniques are capable infiltrating the porosity within the tube walls 38, with the result that a portion of the deposited material fills the porosity between at least the sintered particles that make up the surface regions of the walls 38.

In addition to reducing porosity following the 3D printing of the tube 32, it is also within the scope of the invention to incorporate a density-increasing fill material into the tube 32 during the process of printing the tube 32, such that gaps between adjacent fused particles are at least partially filled within each sintered layer as the layer is formed. 3D printing and deposition processes combined in this manner can be employed to form a composite or alloyed material that may be stronger, more corrosion resistant, and/or more wear resistant than the fused powder material or fill material. Examples of this approach include performing a 3D printing technique using a high energy source (for example, an E-beam, ion beam, or laser beam) within a controlled environment that contains a metallic solution, or combining the 3D printing technique with a slurry ink jet printing technique, or combining the 3D printing technique with a CVD technique. As a particular but nonlimiting example, the 3D printing process can be performed in an environment that contains a metallic solution, such as a metal-organic or inorganic metal-based solution (for example, a nickel, manganese or iron chloride, sulfide or sulfamate, etc.) that decomposes at the elevated temperature of the high energy beam to increase the density of each sintered layer as it is formed by at least partially filling gaps between adjacent particles within the layer. As another example, the 3D printing process can be performed in an environment that contains a metal-based gas (for example, silane, tungsten fluoride, titanium chloride (TiCl₂, TiCl₃, or TiCl₄), or another metal-based gas used in CVD processes) that decomposes at the elevated temperature of the high energy beam to increase the density of each sintered layer as it forms. Yet another example is to spray a liquid, slurry or gas metallic compound (for example, tungsten, silicon, titanum, or iron-containing chloride, hydride or fluoride compound gases, such as SiF₄, SiCl₄, WF₆, SiH₄) onto the surface of each layer as it is being sintered. Spraying can be performed with an ink jet of a type used for 3D metallic writing, and the sintering and spraying operation can be performed in a vacuum or an environment filled with an inert gas to prevent oxidation of the metal particles and deposited metal.

The above printing, annealing and deposition process steps can be performed in batch operations. For example, with appropriate fixturing deposition steps can be similar to those employed in the semiconductor industry, for example, to coat wafers.

The round tube cross-sections represented in FIGS. 3A-D, 4, 5, 6 and 7 offer a significant improvement over micromachined tubes that have square or rectangular-shaped channel cross-sections conventionally formed by wafer bonding and etching (e.g., DRIE) techniques. In particular, corners present in square and rectangular-shaped channels tend to trap air, form gas bubbles, and promote turbulent flow. Round-shaped channels 34 capable of being produced by 3D printing can avoid or at least reduce such drawbacks, and coating and electropolishing the inner surface of the tube wall 38 can avoid or at least reduce bubble nucleation. As previously noted, materials deposited to seal the porosity (FIG. 6) or fill the porosity (FIG. 7) can be the same as the material of the fused particles or selected to promote other desired properties of the tube 32, for example, the strength, corrosion resistance, and/or wear resistance of the tube walls 38.

FIGS. 8 through 11D schematically represented several different designs of sensor structures that incorporate a resonating tube and other structures formed by 3D printing. As noted above, various drive and sensing features can be integrated onto a 3D-printed tube, for example, as represented in FIG. 4, including optical films for optical sensing, piezoelectric films for drive and sensing elements, and capacitive, magnetic, inductive, piezoresistive, and bimetallic films for drive and sensing elements. Preferred embodiments of the invention omit the planar platform shown in FIG. 4 as supporting the insulating layer 40 and electrical feature(s) 42. Instead, FIGS. 8 through 11D schematically represent sensor structures of types in which drive and sensing elements can be incorporated onto a 3D-printed tube. Lorentz-force magnetic drive and sensing elements are particularly well suited for incorporation onto the tube. Other features well suited for incorporation onto the tube include resistance temperature detectors (RTD) for monitoring the temperature of a 3D-printed tube for more accurate assessment of flow, density, etc., of a fluid flowing through the tube.

FIG. 8 represents a sensor structure 50 that includes an integrated resonating tube 52 as a sensing element and a frame 54 as a support element for the tube 52. The tube 52, its fixation point 58 within or on the frame 54, and optionally also the frame 54 are produced during a single 3D printing operation. The tube 52 has a profile that may be referred to as C-shaped or omega-shaped. The tube 52 is cantilevered from the frame 54, which surrounds the tube 52 on four sides to define an aperture 56 into which the tube 52 projects from its fixation point 58 located on one side of the frame 54. Inlet and outlet ports 60 of the tube 52 are defined in the frame 54 at the fixation point 58. As evident from FIG. 8, the fixation point 58 is not truly a point, but instead is a line or region at or by which the tube 52 is or can be supported. Nonetheless, the term “fixation point” will be used herein as a matter of convenience.

As a Lorentz-force resonating device, the sensor structure 50 includes devices for magnetically driving the tube 52 at resonance and sensing elements for sensing the vibration of the tube 52. As known in the art, Lorentz forces are generated when an electric current passes through a magnetic field. In the example of the sensor structure 50 operating as a Lorentz-force resonating device, the structure 50 utilizes drive features that include an excitation means adapted to generate an electric (alternating) current in the wall of the tube 52, for example, through induction, and a magnet means adapted to generate a magnetic field that is transverse to the direction of the current in the tube 52. The magnetic field exerts, through interaction with the current flowing through the tube 52, electromagnetic (Lorentz) forces on the tube 52 that can be used to cause the tube 52 to twist about its axis 62 that passes through the fixation point 58. In this manner, a vibrational motion can be induced in the tube 52 whose resonant frequency and amplitude are dependent on the mass/density and flow rate of a fluid flowing through the tube 52.

In the embodiment of FIG. 8, the frame 54 provides two locations 64 at which transformer cores (not shown) can be mounted to the frame 54 as the source from inducing current flow in the tube 52. A magnet (not shown) for generating a magnetic field transverse to current flow in the tube 52 can be mounted to the frame 54 on the same side as the fixation point 58. The sensor structure 50 may utilize a wide variety of sensing features, a particular example of which is an optical sensor adapted to detect optical reflectors mounted directly to the tube 52. For this purpose, the frame 54 is represented as providing a location 66 at which an optical sensor (not shown) can be mounted to the frame 54 to monitor optical reflectors formed on the tube 52 by 3D printing. As a nonlimiting example, the reflectors can take the shape of vanes that project out of the plane of the tube 52.

The Lorentz-force resonating sensor structure 50 described above has a relatively simple structure that can be entirely formed by 3D printing. A prerequisite is that the tube 52 must be electrically conductive, but processing of the structure 50 can be reduced as a result of avoiding the necessity to deposit multiple insulating and conductive layers on the outer surface of the tube 52.

FIGS. 9A and 9B schematically represent another Lorentz-force resonating sensor structure 70 that may be entirely formed by 3D printing. As with the embodiment of FIG. 8, the complex tube and frame structure shown in FIGS. 9A and 9B can be 3D printed as a single component without the need for any assembly, though it is also within the scope of the invention that the structure 70 could comprise substructures that are each individually produced by 3D printing and then assembled. The structure 70 is similar to the structure 50 of FIG. 8, and differs primarily as a result of its fixation point 78 being located within the aperture 76 and its tube 72 being bent over the fixation point 78 so that the tube 72 is cantilevered from the frame 74, which surrounds the tube 72 on four sides, but the tube 72 lies outside of the plane of the frame 74. As with the structure 50 of FIG. 8, the structure 70 of FIGS. 9A and 9B has inlet and outlet ports 80 that are defined at the fixation point 78, two locations 84 at which transformer cores (not shown) can be mounted to the frame 74 as the source from inducing current flow in the tube 72, and a location 86 at which an optical sensor (not shown) can be mounted to the frame 74 to monitor optical reflectors (e.g., vanes) formed on the tube 72 by 3D printing. As a nonlimiting example, the reflectors can take the shape of vanes that project out of the plane of the tube 52.

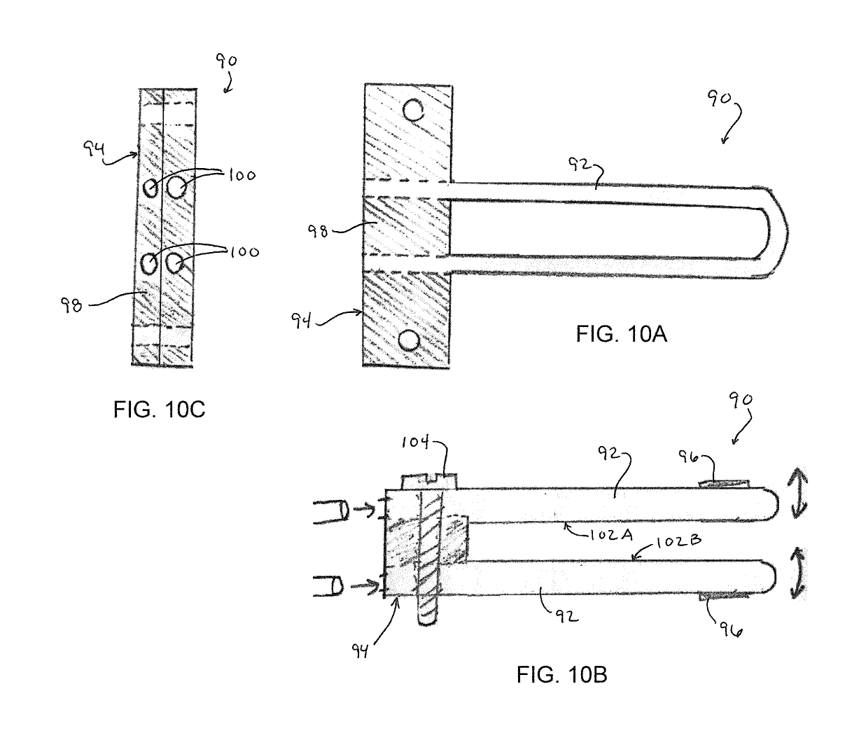

FIGS. 10A through 10C schematically represent another sensor structure 90 that may be entirely formed by 3D printing. As with the embodiments of FIGS. 8, 9A and 9B, the structure 90 may utilize Lorentz forces to induce vibration in a tube structure, which in the case of FIGS. 10A-10C includes a pair of U-shaped tubes 92 cantilevered from a frame 94, though various other drives may be employed. For example, each tube 92 is represented as being produced to have a metal runner 96, with which vibration can be induced in the tubes 92 using various techniques, including but not limited to electrostatic forces (capacitive forces), electromagnetic forces, thermally-based actuation forces (such as bimorph, shape memory alloy, and thermopneumatic), and piezoelectric forces. As with the structures 50 and 70 of FIGS. 8, 9A and 9B, the structure 90 of FIGS. 10A-10C has inlet and outlet ports 100 that are defined at a fixation point 98 formed in the frame 94. However, the frame 94 does not surround the tubes 92, and the tubes 92 project in parallel from one side of the frame 94.

As with the embodiments of FIGS. 8, 9A and 9B, the complex tube and frame structure shown in FIGS. 10A-10C can be 3D printed as a single component without the need for any assembly. Even so, the structure 90 shown in FIGS. 10A-10C is depicted as an assembly of two substructures 102A and 102B that are each individually produced by 3D printing. Each substructure 102A/B comprises one of the tubes 92, one set of inlet and outlet 100 for its tube 92, and a portion of the frame 94. FIG. 10B shows the portions of the frame 92 as held together with a fastener 104, though the use of other securement means (for example, adhesives) is also within the scope of the invention. Prior to or after assembly of the substructures 102A and 102B, one or both of the tubes 92 may be trimmed with a high energy beam for the purpose of matching their resonant frequencies and phases. FIG. 10B further shows tubes 106 that may be assembled and welded to the structure 90 to couple the tubes 106 with the inlet and outlet ports 100 located in the frame 94.

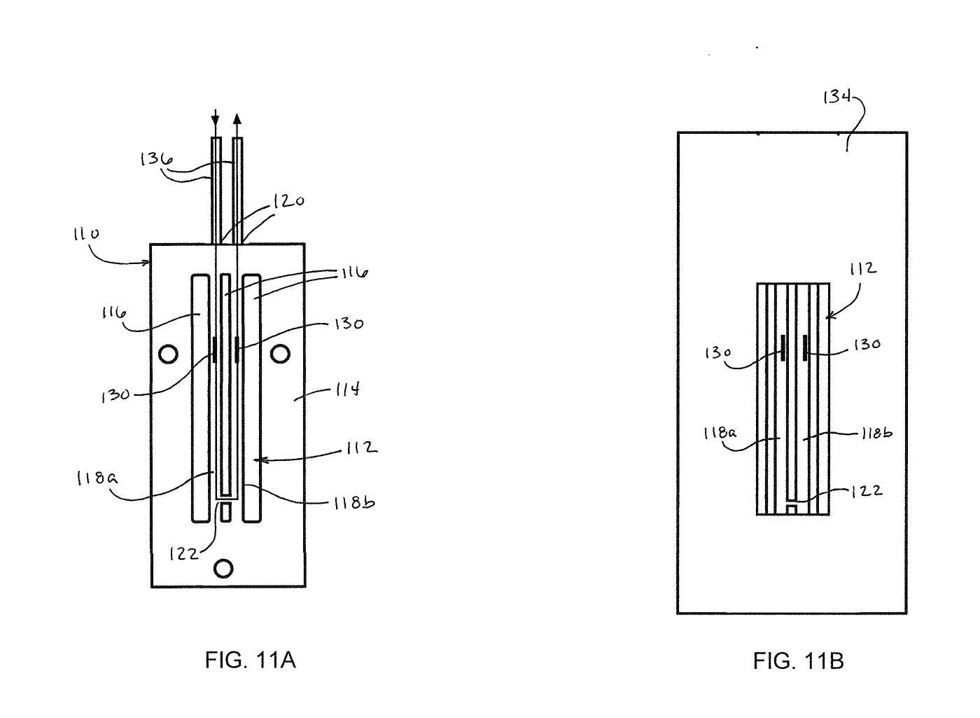

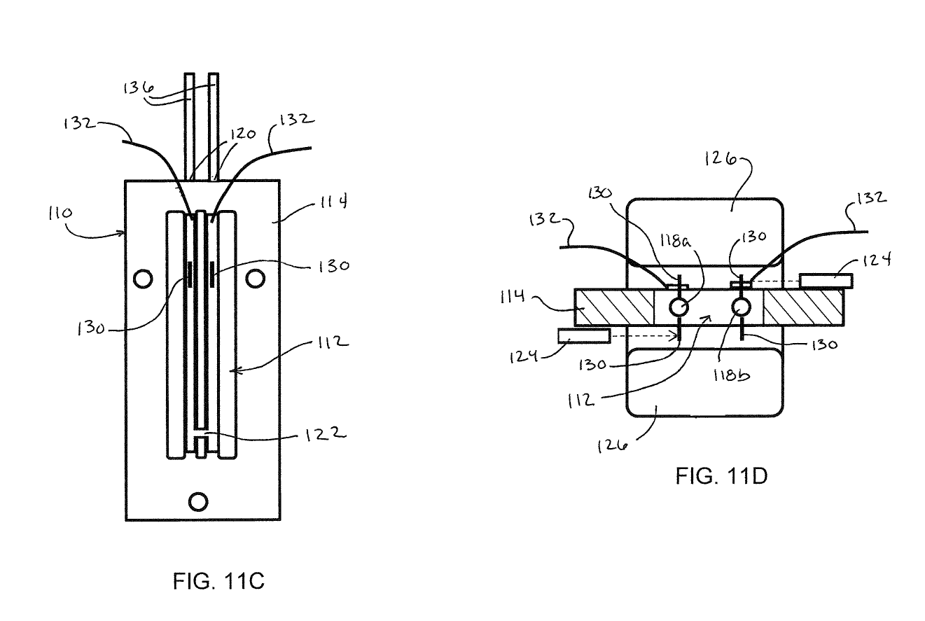

FIGS. 11A through 11D illustrate a method of fabricating a sensor structure 110 as a Lorentz-force resonating device that incorporates drive and sense electrical traces and insulating layers deposited on surfaces of a tube 112 using film deposition and shadow mask techniques to pattern the films. As with previous embodiments, 3D printing enables the tube 112 to be fabricated to have a round exterior and interior surfaces in cross-section to define an interior channel (FIG. 11D) having a round cross-section that reduces the tendency for turbulence and bubble trapping in a fluid flowing through the tube 112. The structure 110 differs from those of FIGS. 3 through 10C in part as a result of the tube 112 having two tube portions 118a and 118b that span an aperture 116 surrounded by a frame 114, with the result that the tube 112 is not cantilevered from the frame 114, but instead effectively has two fixation points at opposite ends of the aperture 116. The tube portions 118a and 118b are fluidically interconnected by a bridge 122 adjacent one end of the tube 112 that is oppositely disposed from the end of the tube 112 nearest inlet and outlet ports 120 through which a fluid enters and exits the structure 110 via a pair of pipes 136 that have been welded to the ports 120.

Vibration is preferably induced in the tube portions 118a and 118b within the plane of the tube 112 and its frame 114. As with prior embodiments utilizing Lorentz forces to induce vibration, a magnet 126 (FIG. 11D) is mounted to the structure 110 of FIGS. 11A-11D for generating a magneticfield transverse to current flow in the tube portions 118a and 118b. The seat for the magnet 26 may optionally be 3D printed at the same time as the tube 112. In place of transformer cores, current flow along the length of each tube portion 118a and 118b is through metal traces deposited on the surfaces of the tube 112 and connected to leads 132. FIG. 11D shows optical sensors 124 mounted on the frame 114 alongside the tube portions 118a and 118b to monitor optical reflectors (e.g., vanes) 130, which may be formed on the tube 112 by 3D printing to project out of the plane of the tube 112. By forming the optical reflectors 130 during 3D printing of the tube 112, proper alignment of the tube 112 and reflectors 130 can be ensured to promote optical sensing of resonance, frequency and phase change during vibration of the tube portions 118a and 118b.

Following fabrication of the sensor structure 110 by 3D printing (FIG. 11A), an insulating layer may be deposited on the entire structure 110 (namely, the tube 112, frame 114, and vanes 130), after which a shadow mask 134 can be employed to selectively deposit the metal traces on the surfaces of the exposed tube 112 (FIG. 11B) to result in the structure 110 represented in FIG. 11C and, after mounting the optical sensors 124 and attaching the leads 132, yield a microfluidic sensor represented in FIG. 11D. Magnetic sense elements (not shown) can be similar deposited on the tube 112.

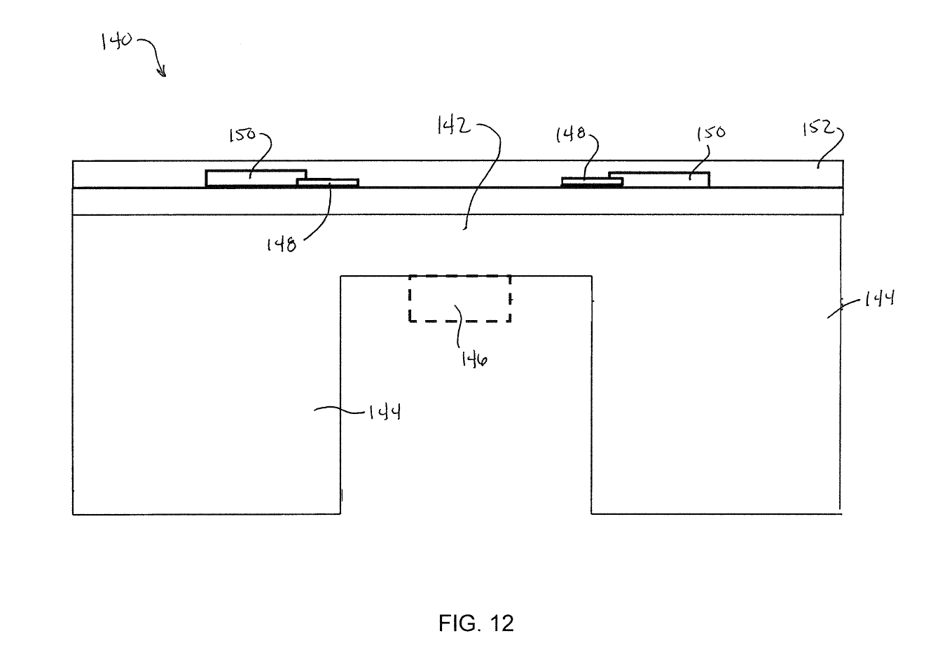

FIG. 12 schematically represents a gauge pressure sensor structure 140 fabricated using 3D printing in combination with film deposition and patterning techniques. The structure 140 includes a diaphragm 142 as a sensing element and a frame 144 as a support element for the diaphragm 142, such that the diaphragm 142 spans a cavity surrounded by the frame 144 and the portion of the frame 144 immediately adjacent the diaphragm 142 serves as a continuous fixation point of the diaphragm 142. Optionally, the portion of the frame 144 opposite the diaphragm 142 can form a site for threaded or welded attachment. FIG. 12 represents strain gauge elements 148 located on the upper surface of the diaphragm 142, and a boss 146 located at the center of the lower surface of the diaphragm 142 to extend the pressure range and improve linearity. The strain gauge elements 148 may be resistors that can be arranged in a full or half Wheatstone arrangement to sense pressure changes. In particular, the strain gauge elements 148 may be piezoresistors, for which various materials may be suitable, for example, silicon, germanium, Si—Ge alloys, polysilicon (P or N-doped). In addition to metal contacts and runners 150, FIG. 12 depicts a passivation layer 152 overlying the strain gauge elements 148 on the sensor structure 140. Under appropriate circumstances, all of the features represented in FIG. 12 may be produced by 3D printing, that at minimum it would be desirable for the diaphragm 142, frame 144, and boss 146 to be simultaneously produced by 3D printing. Other features, for example, the strain gauge elements 148, metal contacts and runners 150, and passivation layer 152, can be produced by deposition methods. Strain gauge elements 148, such as piezoresistive semiconductor or metal foil elements, may also be separately formed and then attached to the 3D-printed diaphragm 142, for example, using an adhesive such as an epoxy, glue, reflowed glass, or solder.

Optimal thicknesses for the diaphragm 142 will depend on its intended pressure measurement range, with thicknesses typically varying from about 10 micrometers to over 1 millimeter. As previously noted with respect to the microfluidic devices of FIGS. 3 through 11D, the particle size of the powder fused with an energy beam to form the sensor structure 140 will affect the surface characteristics and minimum dimensions of the structure 140 and its individual features. Therefore, the use of small particles will often be preferred, for example, maximum dimensions of preferably not greater than 10 micrometers and more preferably about 10 to about 100 nanometers. Additionally, particle size and the thicknesses of the individual sintered layers formed by fusing the particles will determine the minimum thickness possible for the diaphragm 142. Therefore, there will generally be a preference for thin individual sintered layers, for example, maximum thicknesses of preferably not greater than 2000 micrometers and more preferably up to about 10 micrometers. The diaphragm 142 may be initial produced to be thicker than its final intended dimensions, allowing for trimming and smoothing of its surfaces, for example, using an electro polishing or plasma etching technique, to alter a mechanical property thereof (e.g., its sensitivity to pressure). As previously noted with prior embodiments, porosity within the sensor structure 140 may be sealed by depositing materials on the surfaces of the structure 140 or filled by infiltrating the porosity, and such materials may be the same as the material of the fused particles that form the structure 140 or different from the material of the fused particles and selected to promote desired properties of the diaphragm 142, for example, its strength, corrosion resistance, and/or wear resistance.

Generally relating to any of the sensor structures described above, mounting holes for bolts or screws as well as other packaging features can be 3D printed as part of their frames. Further, an array or panel of such sensor structures can be simultaneously 3D printed with the use of appropriate frames and tabs, and sensor structures can be singulated by sawing or laser cutting after the fabrication steps discussed above have been completed. Following singulation, the sensor structures can be vacuum packaged within an appropriate housing to increase the Q and sensitivity of their resonating tubes or diaphragms. In some instances, part or all of the housing can be 3D printed along with the sensor structure. Because 3D printing techniques can be performed with more than one powder material, different portions of the sensor structures and other structural features thereof can be produced from different materials selected to promote the particular function of the feature.

In addition to those features discussed above, it is foreseeable that sensor structures could be 3D printed to have other or additional features, for example, a sieve or filter that can be 3D printed as part of a flow or pressure sensor, and pressure snubbers to reduce water hammer failure from high pressure transients or spikes. Finally, while flow resonating tube mass flow sensors and pressure sensing diaphragms are depicted in the drawings, other types of sensor structures can also be produced with 3D printing techniques discussed above, for example, vortex, thermal, differential pressure, and rotary flow meters and sensors.

While the 3D printing processes described above are particularly well suited for producing very small sensor structures, for example, 2 cm×2 cm or smaller and with feature sizes of 20 micrometers or less, these processes can also be employed to produce larger sensor structures. In either case, 3D printing processes have the advantage of being well suited for making relatively smaller batches in comparison to conventional silicon wafer processing, can use starting materials that are less expensive than polished silicon wafers, and produce sensor structures formed of weldable metals instead of fragile silicon or silicon nitride tubes.

While the invention has been described in terms of specific embodiments, it is apparent that other forms could be adopted by one skilled in the art. For example, the physical configurations of the sensor structures could differ from that shown, and materials and processes/methods other than those noted could be used. Therefore, the scope of the invention is to be limited only by the following claims.

1. A sensor structure comprising at least a support element coupled to a sensing element, the support element and the sensing element being a single integral component formed of particles fused together by a three-dimensional printing technique.

2. The sensor structure according to claim 1, wherein the sensing element comprises at least one tube configured for a fluid to flow therethrough and adapted to measure at least one of Coriolis mass flow, density, viscosity and chemical concentration of the fluid, and the support element comprises a frame from which the tube projects and ports fluidically connected to the tube.

3. The sensor structure according to claim 2, wherein the tube is a resonating tube and the sensor structure further comprises drive means and sensing means for, respectively, inducing vibration in the tube and sensing movement of the tube.

4. The sensor structure according to claim 3, wherein the drive means utilizes Lorentz forces to induce vibration in the tube.

5. The sensor structure according to claim 3, wherein the sensing means comprises optical reflectors that, with the support element and the sensing element, is a portion of the single integral component formed of the particles fused together by the three-dimensional printing technique.

6. The sensor structure according to claim 1, wherein the sensing element comprises at least one diaphragm configured to respond to pressure, and the support element comprises a frame that surrounds and supports the diaphragm.

7. The sensor structure according to claim 6, further comprising strain gauge elements deposited and patterned on the diaphragm.

8. The sensor structure according to claim 1, wherein the particles are formed of a first material and are fused together to define porosity within the support element and the sensing element, and the porosity is sealed at surfaces of the sensing element by a layer of a second material.

9. The sensor structure according to claim 8, wherein the second material is different from the first material and the layer of the second material promotes at least one of strength, wear resistance, and corrosion resistance of the sensing element.

10. The sensor structure according to claim 1, wherein the particles are formed of a first material and are fused together to define porosity within the support element and the sensing element, and the porosity is at least partially filled with a second material.

11. The sensor structure according to claim 10, wherein the second material is an alloy of the first material formed by alloying the first material with a third material introduced into the porosity.

12. The sensor structure according to claim 10, wherein the second material is a discrete material within the porosity and the first and second materials define a composite material.

13. The sensor structure according to claim 10, wherein the second material is different from the first material and promotes at least one of strength, wear resistance, and corrosion resistance of the sensing element.

14. A method of forming a sensor structure comprising at least a support element coupled to a sensing element, the method comprising a three-dimensional printing technique that forms the support element and the sensing element as a single integral component by fusing particles fused together with a scanning electron, laser or ion beam.

15. The method according to claim 14, further comprising attaching at least one of drive means and sensing means to the sensor structure for, respectively, inducing vibration in the tube and sensing movement of the sensing element.

16. The method according to claim 14, wherein the particles are formed of a first material and are fused together to define porosity within the support element and the sensing element, the method further comprising sealing the porosity at surfaces of the sensing element with a layer of a second material.

17. The method according to claim 14, wherein the particles are formed of a first material and are fused together to define porosity within the support element and the sensing element, the method further comprising at least partially filling the porosity with a second material during the three-dimensional printing technique.

18. The method according to claim 14, wherein the particles are formed of a first material and are fused together to define porosity within the support element and the sensing element, the method further comprising at least partially filling the porosity with a second material after the three-dimensional printing technique has been completed.

19. The method according to claim 14, wherein the particles are fused together to define porosity within the support element and the sensing element, the method further comprising annealing the support structure to decrease the porosity.

20. The method according to claim 14, the method further comprising electropolishing or plasma etching surfaces of the sensing element to smooth the surfaces.

21. The method according to claim 14, further comprising trimming the sensing element to alter a mechanical property thereof.
